(19) United States
(12) Patent Application Publication
(10) Pub. No.: US 2012/0253910 A1
(43) Pub. Date: Oct. 4, 2012

(54) GROUP BUYING INCENTIVIZED BY RISK AND IMPACT ADJUSTED REWARDS

(75) Inventors: George Fortuna, Cold Spring, NY (US); Philip James, New York, NY (US); Andrew Nguyen, Mount Laurel, NJ (US)

(73) Assignee: Lot18, Inc., New York, NY (US)

(21) Appl. No.: 13/416,652

(22) Filed: Mar. 9, 2012

Related U.S. Application Data
(60) Provisional application No. 61/450,988, filed on Mar. 9, 2011.

(51) Int. Cl. G06Q 30/02

(52) U.S. Cl. 705/14.23

(57) ABSTRACT

Disclosed is a system and method for incentivizing online consumers to engage in an online purchase transaction by maximizing the rewards, such as advantageous pricing, coupons, etc., that an online consumer may enjoy if they accept a higher level of risk, such as by making an offer to purchase a product or service early in its online promotional offering, and/or if they undertake certain promotional efforts that are designated by the seller of such product or service to promote the retailer's offering to their social media community.

### CROSS REFERENCE TO RELATED APPLICATION

This application is based upon and claims priority from co-pending U.S. Provisional Patent Application Ser. No. 61/450,988 entitled “Group Buying Incentivized by Risk and Impact Adjusted Rewards,” filed with the U.S. Patent and Trademark Office on Mar. 9, 2011 by the inventors herein, the specification of which is incorporated herein by reference.

### FIELD OF THE INVENTION

This invention relates to systems and methods for customizing pricing of products or services for individual or limited groups of consumer users of an automated retail service, such as a dynamic pricing, purchase incentive-driven electronic commerce system, and more particularly to systems and methods for providing dynamic pricing to varied consumer users of such systems such that consumer users that are willing to take on greater purchase transaction risk and/or are willing to undertake specified tasks designated by an online retailer will receive more beneficial pricing on a giving product or service offering than subsequent consumer users and/or consumer users that do not undertake such retailer-designated tasks.

### BACKGROUND OF THE INVENTION

The Internet is replete with online shopping tools, such that retailers that wish to reach consumers in an online environment regularly struggle with how to best reach their relevant consumer base and how to best promote their products once that target consumer base is identified so as to maximize sales of their products or services. Online retailers may wish to maximally incentivize consumers to buy their products at a desirable price point that maximizes profit for the retailer. However, finding an appropriate balance between consumer incentive (such as a coupon or fixed dollar discount, or setting a price significantly lower than the retailer's competition) and achieved profit can be difficult, particularly in the online environment where there is a huge diversity of consumers. Moreover, it may at times be advantageous to particularly incentivize online consumers to purchase a product or service as early as possible in its online offering, as early purchases may lead other users to purchase later, recognizing an item that is being rapidly sold as a “must have” or “hot” item. However, in such circumstances where a retailer offers incentives to users to spur early purchases, it would be desirable to allow adjustment of the pricing of such product or service for later consumers so as to maximize revenue for the online retailer.

Some online sales systems have provided some measure of varied pricing, such as online auction websites. However, auction platforms are typically not widely used by and are impractical for large retailers with large volumes of products they wish to sell, and likewise are often difficult to fit such traditional retailers' distribution and revenue models. Moreover, such auction platforms are not typically the preferred purchase channel for online shoppers that wish to obtain a specific product or service from a known source, or from the original source or provider of such product or service.

In setting the price at which an online retailer's product or service will be offered for sale, it may be quite difficult for the seller to predict what price is most likely to induce a particularly targeted number of consumers to buy the retailer's product or service, so that the retailer might achieve a planned-for profit. While a dynamic pricing scheme that adjusts in response to consumers' willingness to purchase the product or service could be helpful, to the inventors' knowledge no such systems have been effectively implemented. While statistical models can be used for price setting, such models would not typically account for dynamically changing market conditions, and thus cannot take advantage of situations in which a dynamic change in pricing during an online product or service sale or promotion could increase overall revenue. Further, price-sensitive consumers may be willing to purchase a given product or service at a particular discount, but may be less inclined to engage online retail sales environments in which pricing is variable (such as auction websites and the like), as doing so may result in wasted time and effort if their price tolerance is too low. In these cases, the consumer is more likely to simply not engage the system at all to make a purchase.

Thus, consumers may be less inclined to engage online retail purchase systems without sufficient incentives or rewards to make a purchase, and sellers can have difficulty in determining the best pricing that would maximize sales of their product to such consumers. There thus remains a need in the art for a system and method that could maximize incentives to online consumers to purchase an online retailer's product or service, but that could balance those incentives with the online retailer's need to realize a desired profit on such purchases.

Moreover, online retailers may be challenged by trying to direct consumers' attention to their product or service offerings. However, as many online shoppers are also members of online social media communities, such online social media communities could potentially provide further opportunities for online consumers to share information about a retailer's products or services with their community. Unfortunately, limited incentives exist for inducing the online consumers to push a retailer's offers out to their online community. While many online consumers will spend limited time fixed on a given retailer's website, they may spend significant time on such social media sites. If they could be properly incentivized to share a retailer's offer with their social media community, such interaction could provide the online retailer with significant additional exposure to a wide array of additional potential consumers. There thus also remains a need in the art for a system and method that could incentivize online consumers to share retailers' promotions with their social media networks so as to expand the community of potential consumers that would be exposed to the retailers' products or services.

### SUMMARY OF THE INVENTION

Disclosed is a system and method for incentivizing online consumers to engage in an online purchase transaction by maximizing the rewards, such as advantageous pricing, coupons, etc., that an online consumer may enjoy if they accept a higher level of risk, such as by making an offer to purchase a product or service early in its online promotional offering, and/or if they undertake certain promotional efforts that are designated by the seller of such product or service to promote the retailer's offering to their social media community. With regard to one aspect of a preferred embodiment, the system and method disclosed herein relate to an online, electronic commerce system that is configured to provide a dynamic pricing model that provides pricing and/or incentives at a first level for early consumers, and pricing and/or incentives at least a second level for later consumers, which second level is less financially beneficial to consumers and generates higher revenue per unit for online retailers. In this manner, online consumers may be driven by such purchase incentives to engage in an online purchase transaction with a retailer through such electronic commerce system. With regard to another aspect of a preferred embodiment, the system and method disclosed herein customizes online offers for presentation to online consumers in a format that is particularly configured for such consumer's online social media environment, and provides dynamic pricing and/or incentives that go from a first level offered to the online consumer through their social media channel before such consumer shares the offer through their online social media network, to a second level that is more beneficial to the consumer and yields a higher discount to the consumer after they have shared the offer to some online retailer-designated threshold number of contacts in their social media network.

With regard to more particular aspects of a preferred embodiment, the system and method disclosed herein are particularly configured to: (i) access an electronically stored pricing schedule established by an online retailer to establish pricing and incentives to be offered to online consumers at various stages of an online sales promotion; (ii) generate an electronic offer for online consumers to purchase product at a first price and/or a first incentive; (iii) transmit such electronic offer to a plurality of consumer computers; (iv) receive a plurality of first contingent purchase offers from a first plurality of consumer computers; (v) maintain a count of such plurality of first contingent purchase offers, and upon reaching a first retailer-designated threshold, conduct a purchase transaction with each of the first plurality of consumers (i.e., removing the contingency from the consumers' pending offers so as to close the purchase transaction); (vi) change the price or incentive offered to online consumers to a second price or incentive that is less beneficial to the consumers than the first price or incentive; (vii) generate a revised offer for consumers to purchase the product at the second price or second incentive; and (viii) transmit the revised offer to a second plurality of consumer computers. Preferably, the revised offer has pricing and/or incentives that are less beneficial to online consumers than the original offer, thus providing incentive to drive online consumers to engage in the purchase transaction early in the promotional offering.

Moreover, and with regard to yet other particular aspects of a preferred embodiment, the system and method disclosed herein are particularly configured to: (i) access an electronically stored pricing schedule established by an online retailer to establish pricing and incentives to be offered to online consumers at various stages of an online sales promotion; (ii) generate an electronic offer for online consumers to purchase product at a first price and/or a first incentive; (iii) transmit such electronic offer to a plurality of consumer computers, wherein such electronic offer is particularly formatted for presentation on the user interface of an online social media service that is being accessed by such consumer computer; (iv) receive notice of the consumer user performing tasks designated by the online retailer, such as sharing the offer with such consumer user's contacts in such social media service; (v) maintain a count of such tasks performed by the consumer user; (vi) determine when the count of such tasks performed equals a retailer-designated threshold; and (vii) upon the count of such tasks performed reaching the retailer-designated threshold, applying a modified pricing and/or incentive for the user. Preferably, the modified pricing and/or incentive is of greater financial value to the consumer than the offer originally presented through the online social media service.

### BRIEF DESCRIPTION OF THE DRAWINGS

The numerous advantages of the present invention may be better understood by those skilled in the art by reference to the accompanying figures in which:

FIG. 1 is a schematic view of an exemplary system for implementing a dynamic purchase offer presentation method according to certain aspects of a particularly preferred embodiment.

FIG. 2 is an exemplary view of a portion of a database for use with the system of FIG. 1.

FIG. 3 is an exemplary offer window that may be generated by the system of FIG. 1.

FIG. 4 is an explanatory diagram demonstrating options for presenting offers through various channels.

FIG. 5 is an explanatory diagram demonstrating the adjustment of incentives based on risk assumed by a user of the system of FIG. 1.

FIG. 6 is a flow chart diagram reflecting an exemplary method that may be implemented by the system of FIG. 1.

### DETAILED DESCRIPTION OF THE PREFERRED EMBODIMENTS

The invention summarized above may be better understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The present invention provides a method and system for providing dynamic purchase opportunities through an electronic commerce system providing an online purchasing network that vary offers presented to users of the network, and particularly discounts and other rewards that may be associated with particular offers, based on the particular user's interactions with the purchasing network. More particularly, the dynamic purchase offer presentation system and method disclosed herein are configured to perform the following: (i) maintain an online retailer's (i.e., an entity selling or offering to sell a product or service in an online or otherwise electronic environment, such as the Internet) electronic pricing data that is structured by stages of purchase transaction, such as pricing or incentives to be applied for separate specific numbers of sales carried out during a promotional offering, pricing or incentives to be applied for separate specific levels of revenue received during a promotional offering, pricing or incentives to be applied for specific numbers of promotional tasks undertaken by consumers, and the like; (ii) present offers to a community of potential consumers of the retailer's products or services; (iii) provide pricing and incentives that vary with time based on the number of users committing to purchase under a given pricing and incentive scheme, and/or that vary based on the number of promotional tasks accomplished by the consumer; (iv) maintain a count of offers to purchase under such pricing and incentive scheme, and of promotional tasks accomplished by the consumer; (v) process purchase transactions when a retailer-designated threshold level (number of offers, amount of revenue, etc.) of contingent offers to purchase under a first pricing and incentive scheme is reached; (vi) modify the purchase price and incentive scheme to provide less favorable terms for subsequent consumers that are presented offers after a first retailer-designated threshold level of contingent offers have been received; (vii) modify the purchase price and incentive scheme to provide more favorable terms for a single consumer after such single consumer has performed a retailer-designated number of promotional tasks (such as sharing the retailer's offer with contacts in such user's online social media network); and (viii) customize the visual presentation of the offer to the electronic medium through which the offer is presented, such as formatting the retailer's offer for display on the particular social media website that a given consumer is using to view and access the offer.

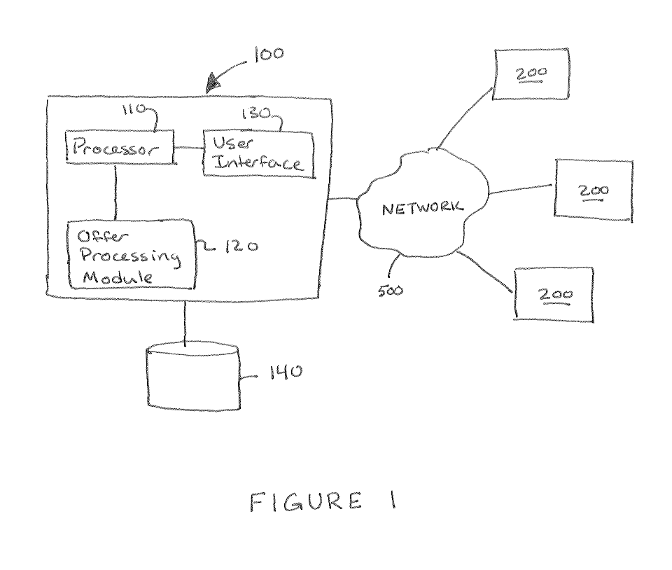

As shown in the exemplary schematic view of FIG. 1, the dynamic purchase offer presentation method may be implemented over a computer system including, by way of non-limiting example, a server computer 100. Server computer 100 may have a processor 110 responsible for overall operation of server computer 100, and logical modules including an offer processing module 120 and a user interface module 130, both of which are in communication with and controlled by processor 110. Server computer 100 may be in electrical communication with one or more client computers 200 connected to server computer 100 over a communications network, such as a wide area network 500 such as the Internet. Each of client computers 200, as set forth herein, may individually comprise an independent computing system, each having its own processor, operating system, user interface, and applications independent of server computer 100, but communicating with server computer 100 in a client/server relationship when a user of such client computer 200 desires to engage the dynamic purchase offer presentation method described herein.

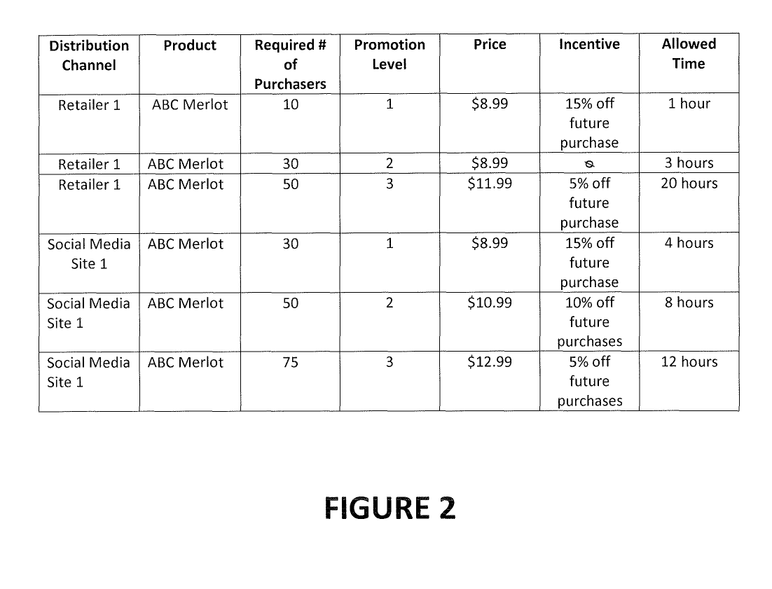

As will be evident to those of skill in the art, server computer 100 is configured to execute computer program modules for providing the functionality described herein. As used herein, the term “module” can refer to computer program logic or instructions for providing the particular functionality performed by such module. A module may be implemented by way of hardware, software, and/or firmware, and is preferably stored on a data storage device that is in data communication with processor 110, loaded into memory, and executed by the server 100 CPU. As will also be evident to those skilled in the art, online retailers wishing to employ the system and method described herein may store catalog information about their products, including detailed product descriptions, pricing and incentive information that will be applicable at various stages of offerings, and related information in one or more databases 140 in communication with server computer 100. In this manner, an online retailer's website and/or online order processing systems may access and display such product information, along with the dynamic pricing and incentive information discussed above, may receive and maintain order and inventory information, may maintain online consumer registration data (usernames, passwords, user identification information, user financial data, etc.), and may likewise maintain any related information of value to the online retailer. Preferably, the pricing data maintained by database 140 maintains the retailer-designated thresholds for pricing and incentives that will be offered to consumers at the various levels of an online promotion, and is accessible and modifiable by the online retailer so as to adjust to changing market conditions. Likewise, such pricing data for a given product may be varied by the online channel through which a consumer accesses the retailer's offer, such as a first pricing and incentive scheme for a product being applicable to purchases made by a consumer interacting directly with the retailer's website, and a second pricing and incentive scheme for the same product being applicable to purchases made by a consumer interacting with the retailer through a social media website. By way of non-limiting example, FIG. 2 provides an exemplary representation of a portion of the types of data contained in database 140.

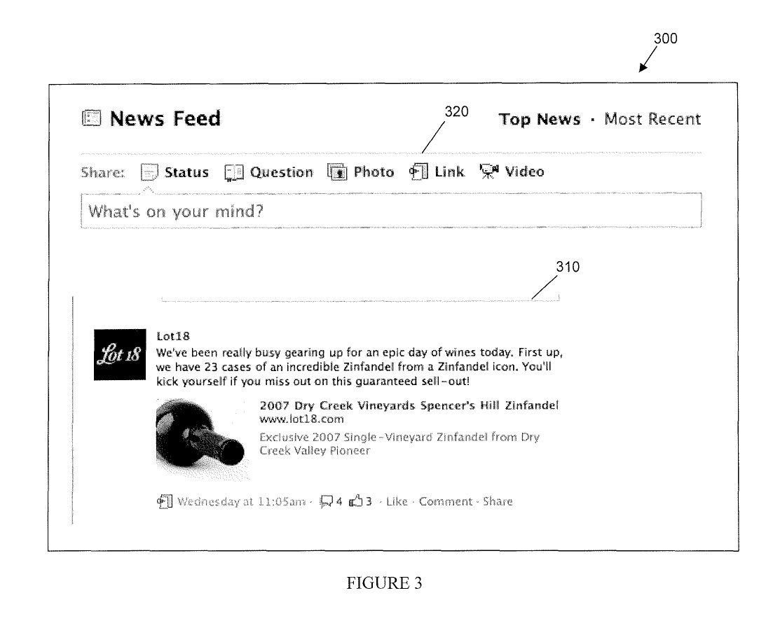

Offer processing module 120 is preferably configured to create, present, and manage electronic offers that are presented to users accessing the dynamic offer presentation system. The shopping instruction knowledge is preferably maintained in database 140 as a collection of rules, templates, and instructions and is accessible by processing module 120. Preferably, the offers comprise an offer to sell a particular product or service that a user of the system may accept. For example, FIG. 3 provides an exemplary view of an offer presentation window 300 that presents a user of the system with a particular offer 310 to sell to such user a product or service. The offer 310 may be presented in a panel on presentation window 300, and may include graphic and textual descriptions of the offer.

User interface module 130 of server computer 100 is preferably configured to format the offer presentation screen for the particular electronic distribution channel through which the offer is to be distributed. More particularly, offers 310 that are presented to users of the system may be distributed through various channels, including by way of non-limiting example, through a website directly associated with the manufacturer or distributor of the product or service, or through various social media websites, such as FACEBOOK and the like. User interface module 130 is preferably configured to detect the channel through which any user accesses the system, and configures the offer to a format appropriate for such channel. In each case, the panels comprising offers 310 will preferably include information, images, and details about the merchandise or service being offered, but such offer 310 will be contained within a presentation window 300 that is particularly customized for the electronic channel through which the user is accessing the system. Thus, the presentation window 300 may also comprise functions 320 that relate to the particular distribution channel. For instance, if the distribution channel comprises a social media website, presentation window 300 may also include functions 320 such as features linking to the user's status on the social media site, sharing the offer with other users, etc.

Thus, for instance, a first user might access server computer 100 through a social media website, in which case presentation window 300 will be customized by user interface module 130 for such first user by formatting the presentation window for inclusion on the social media website's standard interface. Likewise, a second user might access server computer 100 through a product wholesaler's website, in which case the presentation window will be further customized by user interface module 130 for such second user by formatting the presentation window for inclusion on the product wholesaler website's standard interface.

As mentioned above, offer processing module 120 is configured to create and manage offers that are presented to users of the system on client computers 200. Such offers may be formatted as contingent offers to sell the particular product or service pursuant to particular purchase terms, such as at a particularly discounted price, in which case the contingent offer does not become a valid, closable offer until some threshold condition is met. For instance, contingent offers to sell a product at a particularly discounted price may be presented to users, but such offers will remain contingent, and thus not capable of being accepted and closed by the user, until a retailer's pre-designated total number of users have committed to purchase such product or service. A retailer acting as a system manager may configure offer processing module 120 to establish conditions that must be met in order for an offer to become active and, thus, subject to acceptance and purchase by a user. For instance, a system manager may establish a threshold minimum number of consumers that commit to purchasing the product or service offered before the offer becomes active. Alternatively or additionally, the system manager may establish a threshold minimum revenue that must be generated from sales of a particular product or service, preferably within a system manager-established time limit. Optionally, offer processing module 120 may be configured to balance, according to system manager-established criteria, the minimum required number of consumers with the revenue generated within such time limit so as to, for instance, decrease the number of consumers that are required to activate an offer if the offered purchase price is higher, and increase the number of consumers that are required to activate an offer if the offered purchase price is lower.

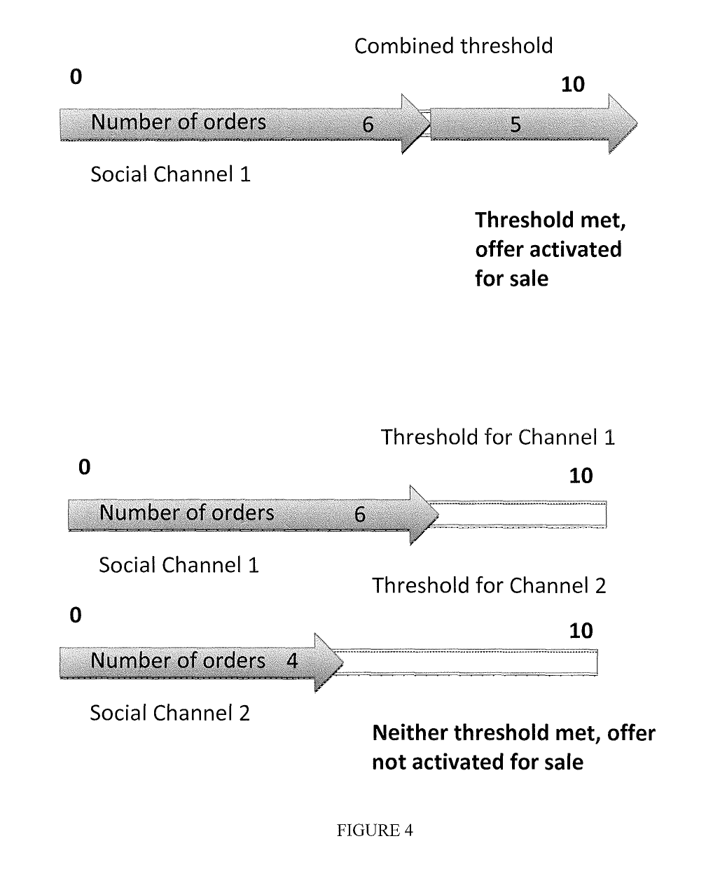

Preferably, the threshold values that are established by the system manager may be extended across a number of different online channels, or may be particularized for specific online channels. Thus, for instance, users accessing the system through a first social media website may be subject to a first threshold being met before their offer may be made active, while users accessing the system through a second social media website, or through a product wholesaler's website, may be subject to a second threshold being met before their offer may be made active. Thus, and with reference to the top explanatory diagram of FIG. 4, the system may provide a combined threshold that extends an offer across a number of different channels, particularly a first channel (designated “Social Channel 1”) and a second channel (designated “Social Channel 2”). In this case, if the system manager has designated that the threshold for such cross-channel offer to sell a product or service is 10 consumers, and 6 consumers commit to purchase the product through Social Channel 1, while 5 consumers commit to purchase the product through Social Channel 2, the threshold will have been achieved, and the system may designate the offer to sell under the offered terms as active, thus allowing each of the consumers using Social Channels 1 and 2 to complete the purchases under such terms. Alternatively, and with reference to the two bottom explanatory diagrams of FIG. 4, the system may provide a threshold that is specific to each of Social Channel 1 and Social Channel 2. In the example shown in FIG. 4, such threshold has been set by a system manager as 10 consumers committing to purchase the particular product. However, as only 6 consumers of Social Channel 1 have committed to purchase, and only 4 users of Social Channel 2 have committed to purchase, neither of the offers presented through these Social Channels may be accepted by any of the users.

The threshold values need not be identical for each channel; thus, if desired, a system manager may designate a first threshold that must be met in order to activate an offer through a first Social Channel, and may designate a second, different threshold that must be met in order to activate an offer through a second Social Channel.

In each case, if the number of users committing to purchase the product or service does not reach the threshold that was established by the system manager, then the offer is not activated for sale, and the users that have committed to such purchase are released from any commitment to purchase the product or service. Preferably in such event, user interface module 130 may generate a message configured for the particular user's channel informing them that the sale offer has been cancelled.

If, however, the threshold number of users committing to purchase the product or service does reach the threshold that was established by the system manager, then the offer is activated for sale. In that case, each of the consumers that had previously committed to purchase the product may complete their purchase transaction, and other users that thereafter desire to purchase the same product or service may likewise conduct such a transaction.

As explained above, in order to incentivize users to engage the system early and to commit to purchasing a product or service, the terms of the purchase transaction may be dynamically modified by offer processing module 120 for various groups of consumers. Thus, for instance, a system manager-designated number of users that initially commit to purchase before an offer is active may, upon activation of such offer by the system (once the predetermined threshold is met), receive discounts, rewards, or other incentives at a first level. Once that first number of users have committed to such purchase, offer processing module 120 may modify the terms of the purchase transaction for later users that commit to purchase the same product or service. Preferably in this case, if such later users still commit to the purchase before the offer activating threshold is met, the purchase terms governing their transaction may include discounts, rewards, or other incentives that are at a lower level or value than the discounts, rewards, or other incentives presented to the users that earlier committed to the purchase, but may be higher than any discounts, rewards, or other incentives granted to still later consumers. In this manner, the discounts, rewards, or other incentives may be varied based upon the risk that a particular user is willing to accept in their individual contingent transaction. The greatest discount, reward, or other incentive will be awarded to the first group of users committing to activate an offer, such that if they are willing to take the early risk to make such commitment, they will receive the greatest benefits that will be associated with a particular product or service purchase.

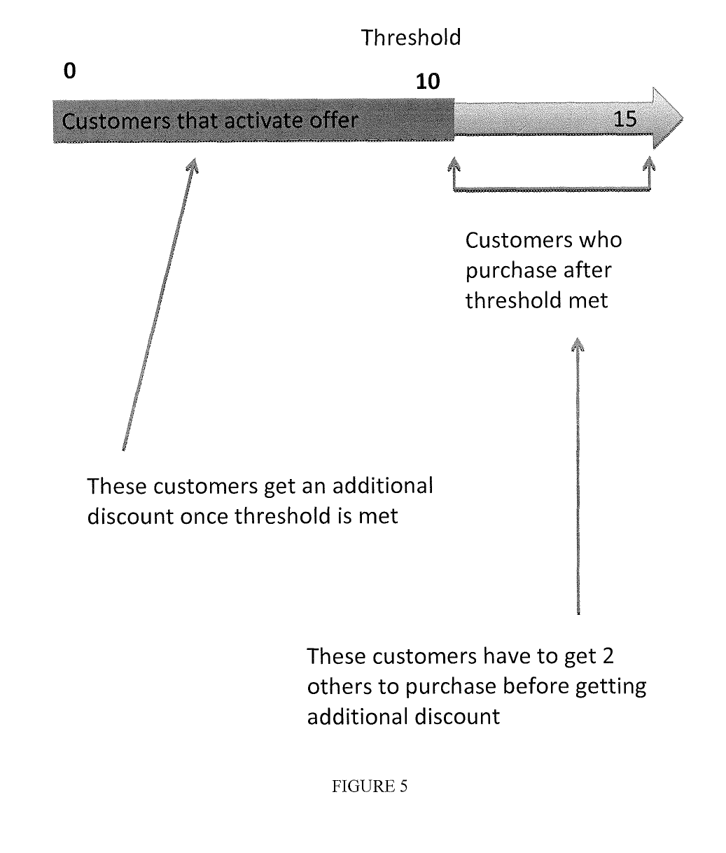

FIG. 5 provides an explanatory diagram reflecting the application of differing levels of discounts, rewards, or other incentives to users that commit to purchase a given product or service at different times.

Optionally, offer processing module 120 may make certain discounts, rewards, or other incentives for later consumers contingent on such later consumers' performance of certain tasks. For instance, if a consumer is not in the initial group of consumers that is entitled to the first level of discounts, rewards, or other incentives, but is nonetheless interested in participating in such purchase and earning a discount, offer processing module 120 may associate contingent discounts, rewards, or other incentives with such later consumer, and activate those discounts, rewards, or other incentives when such later consumer, by way of non-limiting example, successfully directs other consumers to complete a purchase of such product or service.

Moreover, offer processing module 120 may preferably associate discounts, rewards, or other incentives with users regardless of at what point they commit to purchase an offered product or service, but based upon such user's sharing of the offer with other persons. For instance, if a given user purchases a product or service that is the subject of an active offer, their purchase may be subject to terms that include a first, lower level of discounts, rewards or other incentives, or optionally that include no discount, reward or other incentive. If such consumer, however, shares the offer, such as through their social media website, with other potential consumers that ultimately consummate a purchase of such product or service, offer processing module 120 may assign a higher level of discounts, rewards, or other incentives to the terms of such consumer's transaction. In this manner, the consumer may benefit from other parties that interact with the offer based on the consumer's sharing of that offer through their social media network. Optionally, processing module 120 may preferably be configured to vary the extent of discounts, rewards, or incentives that are applicable to such a consumer based on the impact of the consumer's sharing of the offer through their social media network and their participation in inviting later successful consumers to engage in the offer.

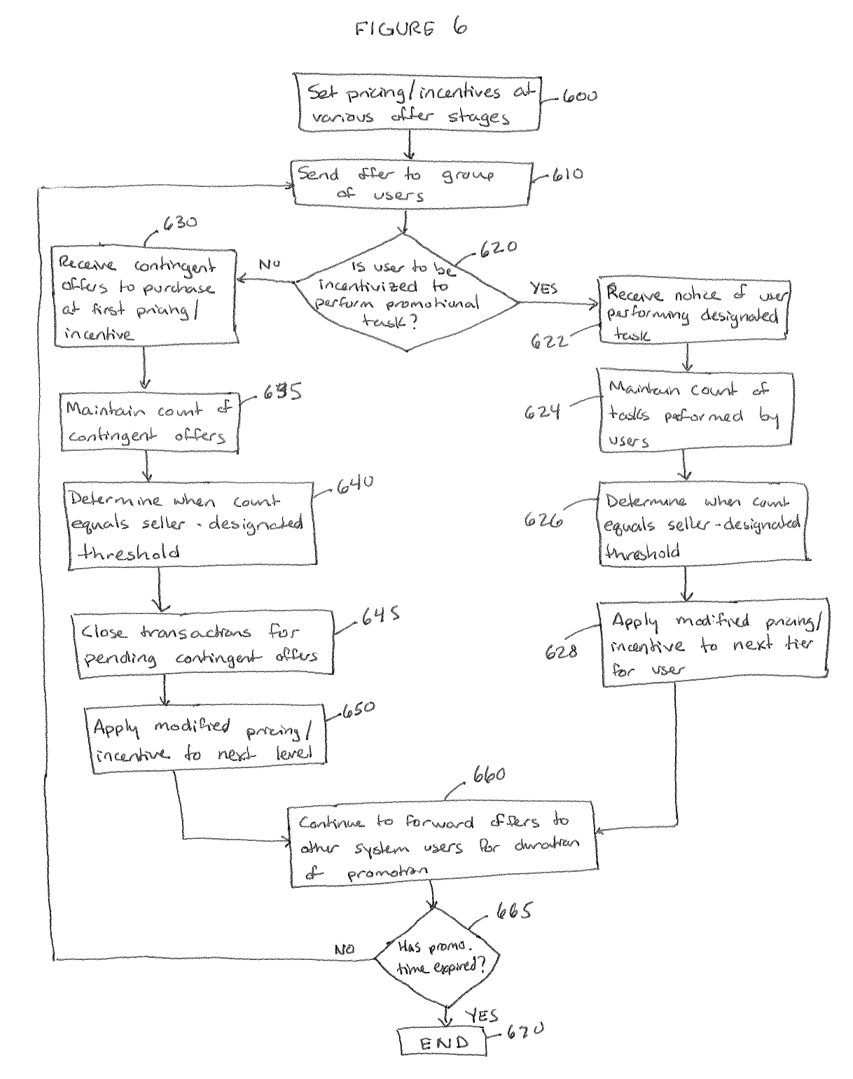

FIG. 6 provides a schematic overview of the exemplary method that may be employed by server computer 100 in accordance with certain aspects of a preferred embodiment of the invention. At a first step 600, an online retailer sets their product pricing and incentives that will control at the various stages of their online promotion, and stores such pricing and incentive data in database 140. Next, at step 610, computer 100 (executing the method on behalf of the retailer) sends a promotional offer to a group of online consumers that are registered with the retailer. At step 620, computer 100 determines whether the consumers are to be incentivized to perform promotional tasks to promote the retailer's offer. If not, computer 100 awaits reception of contingent offers, and at step 630 receives contingent offers to purchase the promoted product at a first pricing and/or incentive level. Then, at step 635, computer 100 maintains a count of contingent offers received by consumer users of the system. At step 640, computer 100 determines when the count of received contingent offers equals the above-described retailer-designated threshold, and at step 645, closes the transaction (i.e., completes the sales transaction) for pending contingent offers when such threshold is reached. Thereafter, computer 100 adjusts the pricing and incentive for such promotion to the next level for subsequent consumers.

If, at step 620, computer 100 determines that the consumers are to be incentivized to perform promotional tasks to promote the retailer's offer, then computer 100 monitors for consumers carrying out such promotional tasks, and at step 622, computer 100 receives notice of one or more consumers performing such designated tasks. Next, at step 624, computer 100 maintains a count of such tasks performed by consumer users, and at step 626 determines when the count of such tasks has reached the retailer-designated threshold. After that determination is made, at step 628, computer 100 applies modified pricing and/or incentives for the user that has reached such count.

After such adjustments are made at steps 628 and 650, computer 100 at step 660 may continue to forward offers to other system users for the intended duration of the promotion. Thus, at step 665, computer 100 determines whether the promotion has expired, and if not, continues the above processes by reverting to step 610 described above. If, however, the retailer's designated time for the promotion has expired, computer 100 terminates the offering at step 670.

Those skilled in the art will recognize that a retailer may operate and/or engage server computer 100 for their benefit, whether or not server computer 100 is located at a retailer's physical place of business, remotely, or event is managed entirely by a third party with multiple retailers accessing the electronic commerce system described herein for the online sale of their products and services. The term “retailer computer” as used herein thus corresponds to all such configurations.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

We claim:

1. A computer implemented method for incentivizing online purchases of a retailer's product using a dynamic pricing arrangement, comprising the steps of:
transmitting from a retailer computer of a dynamic pricing, purchase incentive-driving electronic commerce system an offer to purchase a retailer's product to a plurality of consumer users of such electronic commerce system and at a first pricing and/or incentive level;
receiving at said retailer computer a first plurality of contingent offers to purchase said retailer's product at said first pricing and/or incentive level;
maintaining at said retailer computer a count of said first plurality of contingent offers;
determining at said retailer computer when said count of said first plurality of contingent offers reaches a predesignated threshold level;
upon said first plurality of contingent offers reaching said predesignated threshold level, finalizing at said retailer computer said first plurality of contingent offers to purchase said retailer's product so as to execute purchase transactions of such product;
modifying at said retailer computer said first pricing and/or incentive level to a second pricing and/or incentive level; and
transmitting from said retailer computer a revised offer to purchase said retailer's product to a second plurality of consumer users at said second pricing and/or incentive level.

2. The method of claim 1, wherein said second pricing and/or incentive level is less financially advantageous to said second plurality of consumer users than said first pricing and/or incentive level.

3. The method of claim 1, further comprising the steps of:
receiving at said retailer computer a second plurality of contingent offers to purchase said retailer's product at said second pricing and/or incentive level;
maintaining at said retailer computer a count of said second plurality of contingent offers;
determining at said retailer computer when said count of said second plurality of contingent offers reaches a second predesignated threshold level; and
upon said second plurality of contingent offers reaching said predesignated threshold level, finalizing at said retailer computer said second plurality of contingent offers to purchase said retailer's product so as to execute purchase transactions of such product.

4. The method of claim 1, wherein at least one of said consumer users is a registered user of a social media service and maintains an electronic association with other members of such social media service, the method further comprising the steps of:
formatting said offer to purchase said retailer's product for integrated display with a user interface generated by said social media service.

5. The method of claim 4, further comprising the step of:
receiving at said retailer computer an indication that said at least one consumer user has electronically shared said offer to purchase said retailer's product with at least one of said other members of said social media service within said at least one consumer user's associations.

6. The method of claim 5, further comprising the step of maintaining at said retailer computer a count of instances in which said at least one consumer user electronically shares said offer with members of said social media service within said at least one consumer user's associations.

7. The method of claim 6, further comprising the step of determining at said retailer computer when said count of instances reaches a predesignated sharing instance threshold.

8. The method of claim 7, further comprising the step of upon said count of instances reaching said predesignated sharing instance threshold, applying a further modified pricing and/or incentive level to a contingent offer received at said retailer computer from said at least one consumer user.

9. The method of claim 8, wherein said further modified pricing and/or incentive level is more financially advantageous to said at least one consumer users than said first pricing and/or incentive level.

10. A system for incentivizing online purchases of a retailer's product using a dynamic pricing arrangement, comprising:
a retailer computer having executable computer code stored thereon executing a dynamic pricing, purchase incentive-driven electronic commerce system adapted to:
transmit an offer to purchase a retailer's product to a plurality of consumer users of such electronic commerce system and at a first pricing and/or incentive level;
receive a first plurality of contingent offers to purchase said retailer's product at said first pricing and/or incentive level;
maintain a count of said first plurality of contingent offers;
determine when said count of said first plurality of contingent offers reaches a predesignated threshold level;
upon said first plurality of contingent offers reaching said predesignated threshold level, finalize said first plurality of contingent offers to purchase said retailer's product so as to execute purchase transactions of such product;
modify said first pricing and/or incentive level to a second pricing and/or incentive level; and
transmit a revised offer to purchase said retailer's product to a second plurality of consumer users at said second pricing and/or incentive level.

11. The system of claim 10, wherein said second pricing and/or incentive level is less financially advantageous to said second plurality of consumer users than said first pricing and/or incentive level.

12. The system of claim 10, wherein said executable code is further configured to:
receive a second plurality of contingent offers to purchase said retailer's product at said second pricing and/or incentive level;
maintain a count of said second plurality of contingent offers;
determine when said count of said second plurality of contingent offers reaches a second predesignated threshold level; and
upon said second plurality of contingent offers reaching said predesignated threshold level, finalize said second plurality of contingent offers to purchase said retailer's product so as to execute purchase transactions of such product.

13. The system of claim 10, wherein at least one of said consumer users is a registered user of a social media service and maintains an electronic association with other members of such social media service, and wherein said executable code is further configured to:
format said offer to purchase said retailer's product for integrated display with a user interface generated by said social media service.

14. The system of claim 13, wherein said executable code is further configured to:
receive an indication that said at least one consumer user has electronically shared said offer to purchase said retailer's product with at least one of said other members of said social media service within said at least one consumer user's associations.

15. The system of claim 14, wherein said executable code is further configured to maintain a count of instances in which said at least one consumer user electronically shares said offer with members of said social media service within said at least one consumer user's associations.

16. The system of claim 15, wherein said executable code is further configured to determine when said count of instances reaches a predesignated sharing instance threshold.

17. The system of claim 16, wherein said executable code is further configured to, upon said count of instances reaching said predesignated sharing instance threshold, apply a further modified pricing and/or incentive level to a contingent offer received at said retailer computer from said at least one consumer user.

18. The system of claim 17, wherein said further modified pricing and/or incentive level is more financially advantageous to said at least one consumer users than said first pricing and/or incentive level.
